(19) United States
(12) Patent Application Publication
(10) Pub. No.: US 2013/0173320 A1
(43) Pub. Date: Jul. 4, 2013

(54) METHOD AND SYSTEM UTILIZING MERCHANT SALES ACTIVITY TO PROVIDE INDICATIVE MEASUREMENTS OF MERCHANT AND BUSINESS PERFORMANCE

(71) Applicants: Jeff BANK, Coto de Caza, CA (US); Rohit Chauhan, Somers, NY (US); Michael Cimatu, Bel Air, MD (US); Kenny Unser, Fairfield, CT (US); Serge Bernard, Danbury, CT (US)

(72) Inventors: Jeff BANK, Coto de Caza, CA (US); Rohit Chauhan, Somers, NY (US); Michael Cimatu, Bel Air, MD (US); Kenny Unser, Fairfield, CT (US); Serge Bernard, Danbury, CT (US)

(73) Assignee: MASTERCARD INTERNATIONAL INCORPORATED, Purchase, NY (US)

(21) Appl. No.: 13/339,634

(22) Filed: Dec. 29, 2011

(51) Int. Cl. G06Q 10/06

(52) U.S. Cl. 705/7.11

(57) ABSTRACT

A system for measurements of merchant performance using a payment card processing system, the system includes a managing computer system of a payment card service provider, the managing computer system having a memory device capable of storing data for generating measurements of merchant performance based on payment card transactions, and a computer processor. The computer processor is configured to: receive payment card transactions from at least one merchant; store the payment card transactions for the at least one merchant; generate at least one business performance indicator for the payment card transactions of the at least one merchant; compare the at least one business performance indicator for the at least one merchant to a comparable business performance indicator; and generate a measurement of merchant performance for the at least one merchant based on the comparison of the at least one business performance indicator to the comparable business performance indicator.

### FIELD

The present invention relates to a system and method, which utilizes merchant sales activity to provide indicative measurements of merchant and business performance, and more particularly, a system and method, which utilizes payment card transaction to monitor merchant sales activity, and which provides indicative measurements of merchant and business performance.

### BACKGROUND

Merchants often want to monitor and review their company and/or business performance. In addition, company and/or business performance is often sought by third parties for decisions on extending credit, investments, business-to-business (B2B) marketing, stock valuations, guidance for consumers and/or customers as to preferred merchants and businesses. Accordingly, it would be desirable to provide merchants and/or business, third parties and consumers with indicative measurements of merchant and/or business performance based on payment card transactions, which provides company trending and comparisons in the same and/or similar industries.

### SUMMARY

In accordance with an exemplary embodiment, a system for measurement of merchant performance using a payment card processing system, the system comprises: a managing computer system of a payment card service provider, the managing computer system having a memory device capable of storing data for generating measurements of merchant performance based on payment card transactions, and a computer processor configured to: receive payment card transactions from merchants; store the payment card transactions for merchants; generate business performance indicator for the payment card transactions of merchants; compare the business performance indicator for the merchant to a comparable business performance indicator; and generate a measurement of merchant performance for the merchant based on the comparison of the business performance indicator to the comparable business performance indicator.

In accordance with another exemplary embodiment, a method for measurement of merchant performance using a payment card processing system, the method comprises: receiving payment card transactions from merchants in a managing computer system hosted by a payment card service provider, the managing computer system comprising a memory device capable of storing data and a computer processor for generating and calculating measurements of merchant performance based on payment card transactions; storing the payment card transactions for merchants; generating business performance indicator for the payment card transactions of merchants; comparing business performance indicator for merchants to a comparable business performance indicator; and generating a measurement of merchant performance for merchants based on the comparison of business performance indicator to the comparable business performance indicator.

### BRIEF DESCRIPTION OF THE DRAWINGS

The exemplary embodiments of the disclosed systems and methods can be better understood with reference to the following drawings and description. The components in the figures are not necessarily to scale, emphasis instead being placed upon illustrating the principles of exemplary embodiments of the disclosed system. Moreover, in the figures, like reference numerals designate corresponding parts through the different views.

FIG. 1 illustrates a high-level diagram of a system architecture that may be employed in accordance with an exemplary embodiment.

FIG. 2 illustrates a block diagram of a managing computer system for a payment card service provider in accordance with an exemplary embodiment.

FIG. 3 illustrates a flowchart illustrating the process in which the system utilizing merchant sales activity to provide indicative measurements of merchant and business performance can be carried out.

FIG. 4 illustrates another flowchart illustrating the process in which the system utilizing merchant sales activity to provide indicative measurements of merchant and business performance can be carried out.

Further areas of applicability of the present disclosure will become apparent from the detailed description provided hereinafter. It should be understood that the detailed description and exemplary embodiments are intended for purposes of illustration only. Thus, the detailed description and exemplary embodiments are not intended to necessarily limit the scope of the disclosure.

### DETAILED DESCRIPTION

The system and method for utilizing merchant sales activity to provide indicative measurements of merchant and business performance will now be described by reference to the accompanying drawings in which like elements are described with like figure numbers. It should be noted that the claimed invention is not limited to these particular embodiments but rather fully encompasses variations and modifications, which may occur to those skilled in the art.

In accordance with an exemplary embodiment, the system and method described herein provide a framework to utilize payment card transactions to provide indicative measurements of merchant and business performance. In addition, the system and method provides performance metrics and/or measurements of merchant performance, which can be used to provide company trending and comparisons to industry and/or a category of merchants, which provide similar goods and/or services.

A payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

A “payment card processing system” or “credit card processing networks”, such as the MasterCard® network, now exist, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

A “merchant category code” or “MCC” is a four-digit number created by MasterCard® or VISA® and is assigned to a business by the acquirer when the business first starts accepting one of these cards as a form of payment. The merchant category code or MCC is used to classify the business by the type of goods or services it provides. For example, in the United States, the merchant category code can be used to determine if a payment needs to be reported to the IRS for tax purposes. In addition, merchant category codes (or MCCs) are used by card issuers to categorize, track or restrict certain types of purchases.

It would be desirable to provide merchants, business owners and consumers with indicative measurements of the merchants and/or business performance as compared to other similarly situated merchants and/or business. There is a particularly strong need for this with respect to smaller businesses, since larger businesses may have public reporting requirements or other mechanisms for this information to be provided. In accordance with an exemplary embodiment, information pertaining to the performance of merchants and/or businesses can be obtained from the analysis of the use of payment cards at merchants and/or businesses. For example, by monitoring and tracking payment card use and data associated therewith (e.g., payment card transactions) for merchants and/or businesses, one or more business performance indicators or indices can be generated.

In accordance with an exemplary embodiment, the data associated with each and every payment card transaction is transmitted to a managing computer system for a payment card service provider. The data preferably includes at a minimum, a listing of sales amount for each payment card transaction including the type of goods and/or services sold, a total number of goods and/or services sold in each transaction, a total sales amount for each transaction (e.g., gross dollar amount), a total amount refunded for goods and/or services, which have been returned to the merchant and/or business, and a listing of any and all disputed charges for goods and/or services from the merchant and/or business. In addition, for each merchant and/or business, the data associated with each transaction preferably includes a point-of-sale or point-of-purchase (e.g., location of each payment card transaction). The point-of-sale or point-of-purchase provides that for merchants and/or businesses having one or more locations, the location of the merchant and/or business, which generated the sale can be identified.

In accordance with an exemplary embodiment, the business performance indicators or indices can be provided to the merchants and/or businesses for marketing and sales research, investors to provide insight to the habits of each of the merchant's customer bases and merchants and/or businesses, and to consumers to provide insight into the business practices of the merchants and/or businesses. In accordance with an exemplary embodiment, the business performance indicators can include but are not limited to a transaction index, a sales index, an average ticket index, a returns index, a loyalty index, a customer count index, and/or a chargeback index.

In accordance with an exemplary embodiment, the transaction index is an index that will indicate the relative size of the location by taking the number of transactions per month for a given merchant compared to other merchants. For example, the given merchant can be compared to all merchants in a business classification and/or merchant category code (“MCC”). The sales index is an index that will indicate the relative size of the location by taking the average of the sales per month for a given merchant compared to the merchants in the rest of the respective business classification and/or merchant category code (MCC). The average ticket index is based on ratio of merchant's total sales in gross dollar value (“GDV”) divided by total number of transactions over a given period. The returns index is based on data labeled as returns for a particular merchant versus the same information across the other merchants in that business classification or merchant category code for the a given period of time. In accordance with an exemplary embodiment, the returns index can include two calculations: one based on the number of transactions and the other based on the amount of returns in a total monetary unit. The loyalty index is indicative of customer loyalty with respect to the merchant as compared to similar merchants in the respective business classification and/or merchant category code. In accordance with an exemplary embodiment, the definition of loyalty is calibrated to the specific merchant category code since each industry has its own definition of what level of transaction frequency or sales devotion constitutes loyalty. The customer count index is an index that will indicate the relative size of the merchant's customer base by taking the number of unique accounts transacting with a given merchant in a fixed period of time (for example, one year) compared to the merchants in the rest of the respective business classification and/or merchant category code (MCC). The fixed period may be defined uniquely by business classification and/or merchant category code (MCC). In accordance with an exemplary embodiment, two calculations of the loyalty index can be generated, which include one based on the number of transactions and the other based on sales amount. The chargeback index is calculated based on the number of disputed transactions (chargebacks) for a particular merchant versus the same information across the other merchants in that respective business classification and/or merchant category code. For example, the chargeback index can include an index based on the transactions (e.g., number of chargeback transaction over total transactions) and the other index based on amount (e.g., chargeback amount over sales amount).

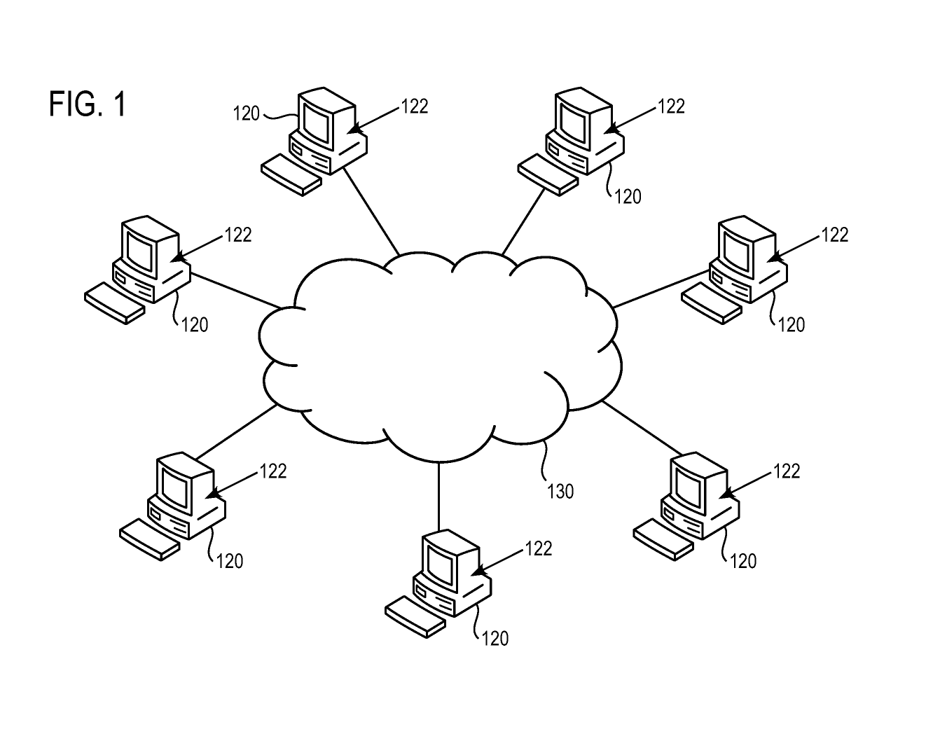

FIG. 1 illustrates a high-level diagram of a system architecture that may be employed in accordance with an exemplary embodiment. As shown in FIG. 1, the system 100 includes a managing computer system 110 for a payment card service provider 112, and a computer system 120 for each of the transaction acquirers and/or merchants 122. The computer system 120 for the transaction acquirers and/or merchants 122 transmits data related to each and every payment card transaction (or at least a statistical sampling) to the managing computer system 110. A network 130 connects the computer system 120 of the transaction acquirer or merchant 122 with the managing computer system 112 of the payment card service provider 112.

The computer system 120 for the attribute provider 122 preferably includes a processor or central processing unit (CPU), one or more memories for storing software programs and data. The computer system 120 also preferably includes an operating system (OS), which manages the computer hardware and provides common services for efficient execution of various software programs. The processor or CPU carries out the instructions of a computer program, which operates and/or controls at least a portion of the functionality of the computer system 120.

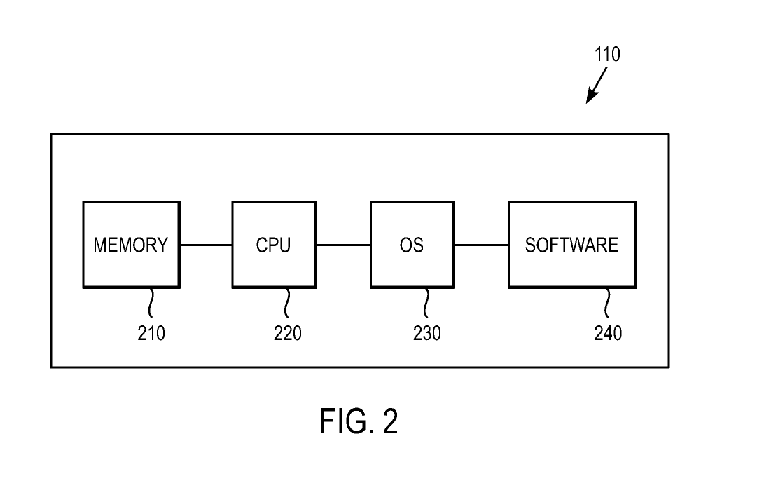

The managing computer system 110 for the payment card service provider 112 as shown in FIG. 2 includes at least one memory device 210 capable of storing data associating identifying information of individual customers and transactions associated with payment card accounts, a computer processor 220, and an operating system (OS) 230, which manages the computer hardware and provides common services for efficient execution of various software programs 240. The processor 220 (or CPU) carries out the instructions of a computer program, which operates and/or controls at least a portion of the functionality of the managing computer system 110.

The network 130 can be nearly any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few.

As illustrated in FIG. 2, the managing computer system 110 includes at least one memory device 210, which may be any form of data storage device including but not limited to electronic, magnetic, optical recording mechanisms, combinations thereof or any other form of memory device capable of storing data, which associates payment card transactions of a plurality of transaction acquirers and/or merchants. The managing computer system 110 also includes a computer processor 220, which may be in the form of a stand-alone computer, a distributed computing system, a centralized computing system, a network server with communication modules and other processors, or nearly any other automated information processing system configured to receive data in the form of payment card transactions from transaction acquirers or merchants 122.

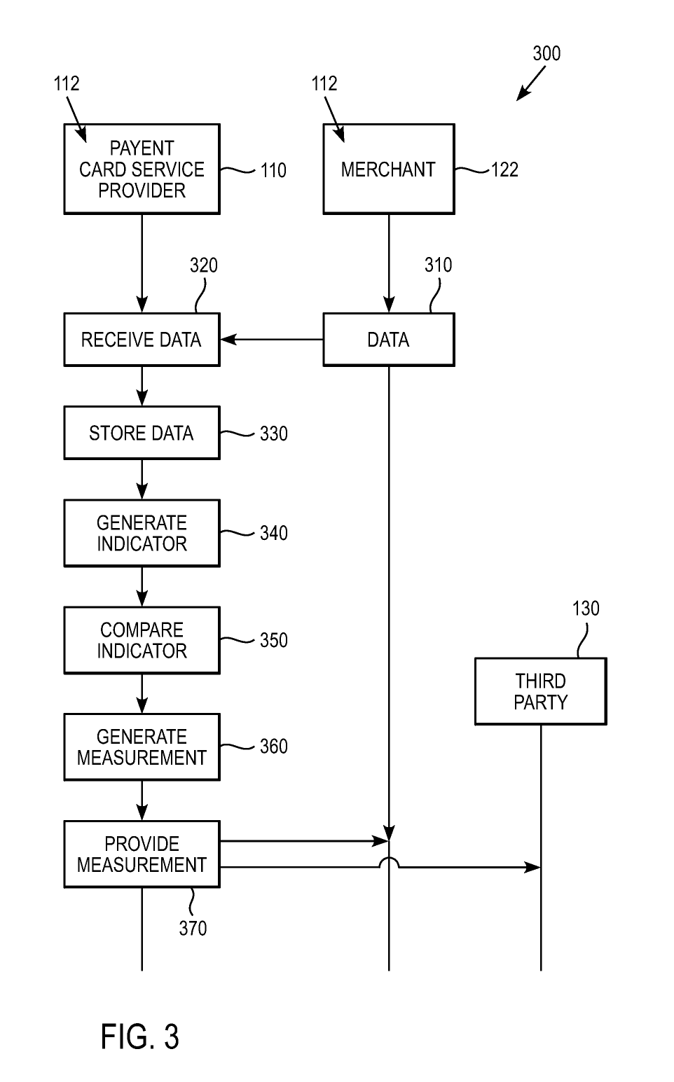

FIG. 3 illustrates a flowchart illustrating the process 300 in which the system for measurements of merchant performance using a payment card processing system can be carried out. This process 300 can be carried out through software compiled on a general purpose computer to make it a specific purpose computer. As shown in FIG. 3, in accordance with an exemplary embodiment, the system includes a managing computer system 110 for a payment card service provider 112, and a computer system 120 for at least one merchant and/or business (e.g., transaction acquirer and/or merchant) 122. For payment card transactions at the at least one merchant, in step 310, the computer system 120 for the merchant and/or business sends data associated with the payment card transaction to the managing computer system 110 for the payment card service provider 112. The data preferably includes among other data, a listing of sales amounts for each and every good and/or service and a point of sale. In step 320, the managing computer system 110 receives the payment card transactions from at least one merchant and/or business 122. In step 330, the managing computer system 110 stores the payment card transactions for each merchant and/or business 122. In step 340, the managing computer system 110 generates at least one business performance indicator for the payment card transactions of at least one merchant 122 based on the payment card transactions received from the at least one merchant and/or business 122. In step 350, the managing computer system 110 compares the at least one business performance indicator for the at least one merchant to a comparable business performance indicator.

In accordance with an exemplary embodiment, the comparable business performance indicator is an indicator of the performance of the at least one merchant 122 and/or a plurality of merchants over a defined period of time for the defined performance indicator. The particular factors that go into the indicator would depend on how they are to be used, and a few examples include the indices discussed below. In step 360, the managing computer system 110 generates a measurement of merchant performance for the at least one merchant 122 based on a comparison of the at least one business performance indicator of the at least one merchant 122 and the comparable business performance indicator of the at least one merchant 122 (e.g., the measurement of merchant performance is compared to the historical or past performance of the at least one merchant itself). In step 370, the measurement of merchant performance is provided to the at least one merchant 122 and/or a third party 130. For example, the measurement of merchant performance can be provided to the at least one merchant and/or business 122 and/or a third party 130, such as customers and/or investors (current and potential), banks, and any other third party wishing to conduct business with the merchant and/or business 122.

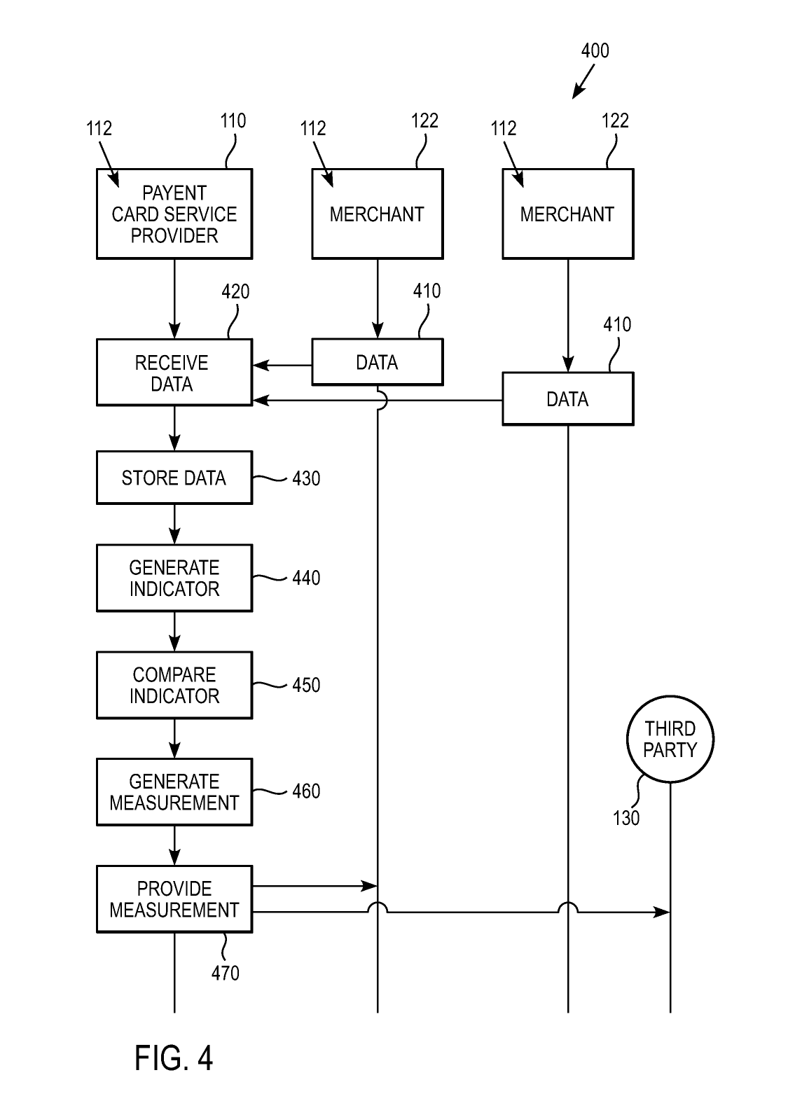

FIG. 4 illustrates another flowchart illustrating the process 400 in which the system for measurement of merchant performance using a payment card processing system can be carried out. As shown in FIG. 4, in accordance with an exemplary embodiment, the system includes a managing computer system 110 for a payment card service provider 112, and a computer system 120 for each of a plurality of merchants and/or businesses 122 (e.g., a plurality of transaction acquirers and/or merchants). For each and every payment card transaction, in step 410, the computer system 120 for each of the merchants and/or businesses 122 sends data associated with the payment card transaction to the managing computer system 110 for the payment card service provider 112. The data preferably includes among other data, a listing of sales amounts for each and every good and/or service and a point of sale. In step 420, the managing computer system 110 receives the payment card transactions from the plurality of merchants and/or businesses 122. In step 430, the managing computer system 110 stores the payment card transactions for each merchant and/or business. In step 440, the managing computer system 110 generates at least one business performance indicator for the payment card transactions of at least one merchant 122 based on the payment card transactions received from the at least one merchant and/or business 122. In step 450, the managing computer system 110 compares the at least one business performance indicator for the at least one merchant 122 to a comparable business performance indicator for the plurality of merchants and/or businesses 122, which sells similar goods and/or services, e.g., within a business classification and/or merchant category code (or MCC). In accordance with an exemplary embodiment, the comparable business performance indicator is the performance of the at least one merchant 122 and/or a plurality of merchants over a defined period (or period of time) for the performance indicator. In step 460, the managing computer system generates a measurement of merchant performance for the at least one merchant 122 based on a comparison of the at least one business performance indicator of the at least one merchant and the comparable business performance indicator for the plurality of merchants and/or businesses 122 within the same and/or similar business classification (i.e., the measurement of merchant performance of the at least one merchant is compared to the comparable performance of all merchants and/or businesses in the same business classification rather than against itself as shown in FIG. 3). In step 470, the measure of merchant performance is provided to the at least one merchant 122 and/or a third party 130. In accordance with an exemplary embodiment, the measurement of merchant performance can be provided to the merchant and/or business, customers, and/or investors (e.g., current and potential investors) in the merchant and/or business 122, banks, and any other third party 130 wishing to conduct business with the merchant and/or business.

In accordance with an exemplary embodiment, the managing computer system 110 can generate a report showing one or more of the business performance indicators, which can be printed and/or displayed on a display device, such as a computer screen and/or other device for the presentation of information in visual and/or tangible form. In accordance with another exemplary embodiment, the merchants are small business, which are not publicly traded and/or merchants, which may be excluded or identifying information observed or dissociated so as to comply with privacy and data usage requirements. However, the system and methods as set forth herein can be applied to any business without regard to business type, size and/or geographical location.

As mentioned above, in accordance with an exemplary embodiment, the business performance indicators can include among others: a transaction index, a sales index, an average ticket index, a returns index, a loyalty index, a customer count index and/or chargeback index.

### Transaction Index

The transaction index is a merchant's total number of transactions for a given period. In accordance with an exemplary embodiment, the transaction index compares a merchant's performance against the merchant and/or business itself. The index is preferably based on a time period, which can include month over month comparisons (e.g., month-to-month); current month versus same month 1 year ago for a 1-year time frame; and current month versus same month 2 years ago for a 1-year time frame. The metrics and/or measurements of merchant performance preferably include percent change, e.g., current period percentage (%) better (or worse) than the comparison period.

Alternatively, or additionally, the transaction index can be used to compare the merchant's performance against all merchants in same merchant category code (or MCC) and/or other business classification. For example, the time periods can include current month, last 6 months, current year (last 12 months), one year ago (13-24 months), and two years ago (25-36 months). In accordance with an exemplary embodiment, all time periods start from last full month. The metrics and/or measurements of merchant performance can include index current month, index for last 6 months, index for last 12 months, index 1 year ago (13-24 months), and index 2 years ago (25-36 months).

### Sales Index

The sale index is a merchant's sales in gross dollar value (GDV) amount for a given period. In accordance with an exemplary embodiment, the sales index compares the merchant's performance against the merchant and/or business itself. The index is preferably based on a time period, which can include month over month comparisons: current month versus same month 1 year ago for a 1-year time frame, current month versus same month 2 years ago for a 1-year time frame. The metrics and/or measurements of merchant performance preferably include percent change, e.g., current period percentage (%) better (or worse) than the comparison period.

Alternatively, the sales index can compare merchant's performance against all merchants in same merchant category code (MCC) and/or business classification. For example, the time periods can include current month, last 6 months, current year (last 12 months), one year ago (13-24 months), and two years ago (25-36 months). In accordance with an exemplary embodiment, each of the time period starts from last full month. The metrics and/or measurements of merchant performance can include index current month, index for last 6 months, index for last 12 months, index 1 year ago (13-24 months), and index 2 years ago (25-36 months).

### Average Ticket Index

The average ticket index is a ratio of merchant's total sales in gross dollar value (GDV) divided by total number of transactions over a given period. In accordance with an exemplary embodiment, the average ticket index compares the merchant's performance against the merchant and/or business itself. For example, the time period is preferably month over month comparisons, which can include current month versus same month 1 year ago for a 1-year time frame, and current month versus same month 2 years ago for a 1-year time frame. The metrics and/or measurements of merchant performance can include percent change, e.g., current period percentage (%) better (or worse) than the comparison period.

Alternatively or additionally, the average ticket index compares merchant's performance against other and/or all merchants in same merchant category code (MCC) and/or business classification. For example, the time periods can include current month, last 6 months, current year (last 12 months), one year ago (13-24 months), and two years ago (25-36 months). In accordance with an exemplary embodiment, each of the time periods start from last full month. The metrics and/or measurements of merchant performance can include index current month, index for last 6 months, index for last 12 months, index 1 year ago (13-24 months), and index 2 years ago (25-36 months).

### Returns Transaction Index

The returns transaction index is the ratio of merchants total number of returns divided by total number of transactions over a given period. The returns transaction index can be used to compare merchant's performance against the merchant and/or business itself. For example, the time periods can include current year (last 12 months), one year ago (13-24 months), and two years ago (25-36 months). In accordance with an exemplary embodiment, the metrics and/or measurements of merchant performance can include percent change current year versus 1 year ago, percent change 1 year ago versus 2 years ago, e.g., current period percentage (%) better (or worse) than the comparison period.

In accordance with an alternative embodiment, the returns transaction index can be used to compare merchant's performance against all merchants in same merchant category code (or MCC) and/or business classification. For example, the time periods can include current month, last 6 months, current year (last 12 months), one year ago (13-24 months), and two years ago (25-36 months). In accordance with an exemplary embodiment, all time periods start from last full month. The metrics and/or measurements of merchant performance can include index current month, index for last 6 months, index for last 12 months, index 1 year ago (13-24 months.), and index 2 years ago (25-36 months).

### Returns $ Amount Index

The return $ amount index is the ratio of merchant's total dollar (or other currency) amount of returns divided by merchant's total Gross Dollar Volume (GDV) amount over a given period. The return $ amount index compares a merchant's performance against the merchant and/or business itself. For example, the time periods can include current year (last 12 months), one year ago (13-24 months), and two years ago (25-36 months). The metrics and/or measurements of merchant performance can include percent change current year versus 1 year ago, percent change 1 year ago versus 2 years ago, (e.g., current period percentage (%) better (or worse) than the comparison period.

Alternatively or additionally, the return $ amount index can be used to compare a merchant's performance against all merchants in same merchant category code (or MCC) and/or business classification. For example, the time periods can include current month, last 6 months, current year (last 12 months), one year ago (13-24 months), and two years ago (25-36 months) where all time periods start from last full month. The metrics and/or measurements of merchant performance can include index current month, index for last 6 months, index for last 12 months, index 1 year ago (13-24 months), and index 2 years ago (25-36 months).

### Loyalty Transaction Index

The loyalty transaction index is a ratio of merchant's total transactions from repeat buyers divided by merchant's total transactions for a given period. The loyalty transaction index compare a merchant's performance against the merchant and/or business itself. For example, the time periods can include current year (last 12 months), one year ago (13-24 months), and two years ago (25-36 months). The metrics and/or measurements of merchant performance can include percent change current year versus 1 year ago, and/or percent change 1 year ago versus 2 years ago (e.g., current period percentage (%) better (or worse) than the comparison period).

Alternatively, the loyalty transaction index can compare merchant's performance against other merchants in same merchant category code (or MCC) and/or business classification. For example, the time periods can include current month, last 6 months, current year (last 12 months), one year ago (13-24 months), and two years ago (25-36 months). In accordance with an exemplary embodiment, all time periods start from last full month. The metrics and/or measurements of merchant performance can include index current month, index for last 6 months, index for last 12 months, index 1 year ago (13-24 months), and index 2 years ago (25-36 months).

### Loyalty: $ Amount Index

The loyalty: $ amount index is a ratio of merchant's total sales amount from repeat buyers divided by merchant's total Gross Dollar Volume (GDV) amount for a given period. The loyalty: $ amount index compare a merchant's performance against the merchant and/or business itself. For example, the time periods can include current year (last 12 months), one year ago (13-24 months), and two years ago (25-36 months). The metrics and/or measurements of merchant performance can include percent change current year versus 1 year ago, percent change 1 year ago versus 2 years ago, e.g., current period percentage (%) better (or worse) than the comparison period.

Alternatively or additionally, the loyalty: $ amount index can be used to compare a merchant's performance against all merchants in same merchant category code (or MCC) and/or business classification. For example, the time periods can include current month, last 6 months, current year (last 12 months), one year ago (13-24 months), and two years ago (25-36 months). In accordance with an exemplary embodiment, all time periods start from last full month. The metrics and/or measurements of merchant performance can include index current month, index for last 6 months, index for last 12 months, index 1 year ago (13-24 months), and index 2 years ago (25-36 months).

### Customer Count Index

The customer count index is the unique accounts that have transacted with the merchant in a given period. In accordance with an exemplary embodiment, the customer count index compares the merchant's performance against the merchant and/or business itself. The index is preferably based on a time period, which can include year over year comparisons: trailing 12 months versus same 12 month period 1 year earlier. The metrics and/or measurements of merchant performance preferably include percent change, e.g., current period percentage (%) better (or worse) than the comparison period.

Alternatively, the customer count index can compare merchant's performance against all merchants in same merchant category code (MCC) and/or business classification. For example, the time periods can include current month, last 6 months, current year (last 12 months), one year ago (13-24 months), and two years ago (25-36 months). In accordance with an exemplary embodiment, each of the time period starts from last full month. The metrics and/or measurements of merchant performance can include index current month, index for last 6 months, index for last 12 months, index 1 year ago (13-24 months), and index 2 years ago (25-36 months).

### Chargeback Transaction Index:

The chargeback transaction index is a ratio of number chargebacks (final disposition) absorbed by the merchant divided by the total number of transactions. In accordance with an exemplary embodiment, the chargeback transaction index can be used to compare merchant's performance against the merchant and/or business. For example, the time periods can include current month, last 6 months, current year (e.g., last 12 months), one year ago (e.g., 13-24 months), and two years ago (e.g., 25-36 months).

In accordance with an exemplary embodiment, the metrics and/or measurements of merchant performance can include rate current month, rate last 6 months, rate current year (last 12 months), rate one year ago (sum of number of chargebacks divided by sum of total number of transaction in the period 13 to 24 months), rate two years ago (sum of number of chargebacks divided by sum of total number of transactions in the period 25 to 36 months).

### Chargeback $ Amount Index

The chargeback amount index is the ratio of $ amount chargebacks (final disposition) absorbed by the merchant divided by the merchant's total Gross Dollar Volume (GDV) amount. The chargeback amount index can be used to compare merchant's performance against the merchant and/or business itself. For example, the time periods can include current month, last 6 months, current year (last 12 months), one year ago (13-24 months), and/or two years ago (25-36 months).

In accordance with an exemplary embodiment, the metrics and/or measurements of merchant performance can include rate current month, rate last 6 months, rate current year (last 12 months), rate one year ago (sum of dollar amount of chargebacks divided by sum of total dollar amount in the period 13 to 24 months.), rate two years ago (sum of amount chargebacks divided by sum of total amount in the period 25 to 36 months).

The previous description of the various embodiments is provided to enable any person skilled in the art to make or use the invention recited in the accompanying claims of the disclosed system. While various exemplary embodiments of the disclosed system have been described above, it should be understood that they have been presented by way of example only, and not limitation. While exemplary embodiments of the disclosed system have been particularly shown and described with reference to embodiments thereof, it will be understood by those skilled in the art that many variations, modifications and alternative configurations may be made to the invention without departing from the spirit and scope of exemplary embodiments of the disclosed system.

Where methods described above indicate certain events occurring in certain order, the ordering of certain events may be modified. Moreover, while a process depicted as a flowchart, block diagram, etc., may describe the operations of the system in a sequential manner, it should be understood that many of the system's operations can occur concurrently.

Thus, the breadth and scope of exemplary embodiments of the disclosed system should not be limited by any of the above-described embodiments but should be defined only in accordance with the following claims and their equivalents.

What is claimed is:

1. A system for measurement of merchant performance using a payment card processing system, the system comprising:
a managing computer system of a payment card service provider, the managing computer system having a memory device capable of storing data for generating measurements of merchant performance based on payment card transactions, and a computer processor configured to:
receive payment card transactions from at least one merchant;
store the payment card transactions for the at least one merchant;
generate at least one business performance indicator for the payment card transactions of the at least one merchant;
compare the at least one business performance indicator for the at least one merchant to a comparable business performance indicator; and
generate a measurement of merchant performance for the at least one merchant based on the comparison of the at least one business performance indicator to the comparable business performance indicator.

2. The system of claim 1, wherein the at least one business performance indicator for the at least one merchant is compared to a comparable business performance indicator for the at least one merchant.

3. The system of claim 1, wherein the at least one business performance indicator for the at least one merchant is compared to a comparable business performance indicator for a plurality of merchants having similar goods and/or services.

4. The system of claim 3, wherein the computer processor is configured to:
store payment card transactions from the plurality of merchants;
generate the comparable business performance indicator for the plurality of merchants; and
generate the measurement of merchant performance for the at least one merchant based on the comparison of the at least one business performance indicator for the at least one merchant and the comparable business performance indicator for the plurality of merchants.

5. The system of claim 3, wherein the comparison of the at least one business performance indicator of the at least one merchant and the plurality of merchants is based on goods and services as defined by the merchant category code (MCC).

6. The system of claim 1, wherein the managing computer system generates a printout and/or a visual display of the measurement of the merchant performance.

7. The system of claim 1, wherein the at least one business performance indicator is a transaction index, a sales index, an average ticket index, a returns index, a loyalty index, a customer count index, and/or a chargeback index.

8. The system of claim 1, wherein the at least one business performance indicator is a transaction index, which is based on a ratio of a total number of transaction for the at least one merchants divided by a total number of transactions for a given period.

9. The system of claim 1, wherein the at least one business performance indicator is a sales index, which is based on a ratio of total sales for the at least one merchant divided by total sales for a given period.

10. The system of claim 1, wherein the at least one business performance indicator is an average ticket index, which is based on ratio of total sales for the at least one merchant divided by total number of transactions for a given period.

11. The system of claim 1, wherein the at least one business performance indicator is a returns index, which is based on a ratio of total returns for the at least one merchant divided by a total number of returns over a given period.

12. The system of claim 1, wherein the at least one business performance indicator is a loyalty index, which is a ratio of a total number of transactions for the at least one merchant from repeat buyers divided by total transactions for a given period.

13. The system of claim 1, wherein the at least one business performance indicator is a customer count index, which is based on a total of unique accounts transacting with the at least one merchant divided by total unique accounts for a given period.

14. The system of claim 1, wherein the at least one business performance indicator is a chargeback index, which is calculated based on a number of disputed transactions for the at least one merchant divided by a total number of transactions for a given period.

15. A method for measurement of merchant performance using a payment card processing system, the method comprising:
receiving payment card transactions from at least one merchant in a managing computer system hosted by a payment card service provider, the managing computer system comprising a memory device capable of storing data and a computer processor for generating and calculating measurements of merchant performance based on payment card transactions;
storing the payment card transactions for the at least one merchant;
generating at least one business performance indicator for the payment card transactions of the at least one merchant;
comparing the at least one business performance indicator for the at least one merchant to a comparable business performance indicator; and
generating a measurement of merchant performance for the at least one merchant based on the comparison of the at least one business performance indicator to the comparable business performance indicator.

16. The method of claim 15, wherein the at least one business performance indicator for the at least one merchant is compared to a comparable business performance indicator for the at least one merchant.

17. The method of claim 15, wherein the at least one business performance indicator for the at least one merchant is compared to a comparable business performance indicator for a plurality of merchants having similar goods and/or services.

18. The method of claim 17, further comprising:
storing payment card transactions from the plurality of merchants;
generating the comparable business performance indicator for the plurality of merchants; and
generating the measurement of merchant performance for the at least one merchant based on the comparison of the at least one business performance indicator for the at least one merchant and the comparable business performance for the plurality of merchants.

19. The method of claim 17, wherein the comparison of the at least one business performance indicator of the at least one merchant and the plurality of merchants is based on goods and services as defined by the merchant category code (MCC).

20. The method of claim 15, wherein the at least one business performance indicator is a transaction index, a sales index, an average ticket index, a returns index, a loyalty index, a customer count index, and/or a chargeback index.

21. The method of claim 15, wherein the managing computer system generates a printout and/or a visual display of the measurement of the merchant performance.
